(19) United States
(12) Patent Application Publication
(10) Pub. No.: US 2019/0174687 A1
(43) Pub. Date: Jun. 13, 2019

(54) MOTOR DRIVE WITH MOISTURE CONTROL FEATURES

(71) Applicant: Franklin Electric Co., Inc., Fort Wayne, IN (US)

(72) Inventors: Douglas C. Lynn, Fort Wayne, IN (US); Robert L. Wetekamp, Fort Wayne, IN (US); Richard J. Halsey, Fort Wayne, IN (US)

(73) Assignee: Franklin Electric Co., Inc., Fort Wayne, IN (US)

(21) Appl. No.: 16/309,440

(22) PCT Filed: Jun. 9, 2017
(86) PCT No.: PCT/US17/36819

§ 371 Date: Dec. 12, 2018

Related U.S. Application Data
(60) Provisional application No. 62/349,097, filed on Jun. 12, 2016.

(51) Int. Cl. A01G 25/16; A01G 27/00; F04B 49/06; G01N 27/22

(52) U.S. Cl. CPC A01G 25/167; G01N 27/223; F04B 49/06; A01G 27/00

(57) ABSTRACT

A method implemented by a motor drive to drive a pump of a liquid pumping system. The method includes receiving a wetness signal from a wetness sensor; determining based on a wetness signal if moisture has been detected by the wetness sensor; discontinuing pumping by the pump responsive to determining that moisture has been detected; after discontinuing pumping, determining if moisture has been detected during a predetermined delay; and restarting pumping if moisture has not been detected during the predetermined delay.

### CROSS-REFERENCE TO RELATED APPLICATIONS

The present international application claims the benefit of U.S. Provisional Patent Application No. 62/349,097, filed Jun. 12, 2016, which is incorporated herein by reference in its entirety.

### FIELD OF THE DISCLOSURE

A method of controlling a motor and a motor drive to implement the method, the method including moisture control features.

### BACKGROUND OF THE DISCLOSURE

Fluid pumping systems use motors to drive pumps and transfer fluids from supply reservoirs such as wells. A sensor measures a characteristic of the fluid, and a motor drive controls the motor to maintain the characteristic near its setpoint. In some systems, the motor drive measures pressure in a fluid circuit and controls the speed of the motor to maintain the pressure near its setpoint.

Fluid pumping systems operate autonomously. Problems arise if leaks develop or the user leaves a valve open, both cases potentially resulting in flooding. For example, if a pipe is broken, the system will continue to pump or will even increase the pumping rate in an attempt to maintain pressure. Water flowing through the broken pipe will thus flood the environment. Flood conditions may result from many causes. For example, a flood condition may occur if a pressure tank breaks, a transducer fails to provide a proper pressure signal, or a pressure relief valve opens due to a high pressure in the system, which may result from a transducer failure or a setpoint set too high.

Improved systems and methods are needed limit or prevent damage caused by unintended flow of liquids pumped by fluid pumping systems.

The background to the disclosure is described herein to explain the context of the present invention. This is not to be taken as an admission or a suggestion that any of the material referred to was published, known or part of the common general knowledge in the art to which the present invention pertains, in the United States or in any other country, as at the priority date of any of the claims.

### SUMMARY

Provided are embodiments of a method for controlling a motor in a pumping system and embodiments of a motor drive to implement the method. In some embodiments, a motor drive to control a motor driving a pump of a fluid pumping system comprises an interface adapted to receive a wetness signal from a wetness sensor operable to sense moisture; an inverter to generate a motor voltage to pump a liquid; and a controller including control logic operable to: determine based on the wetness signal if moisture has been detected by the wetness sensor; cause the inverter to discontinue generating the motor voltage to discontinue pumping responsive to determining that moisture has been detected; after causing the inverter to discontinue generating the motor voltage, determine if moisture has been detected during a predetermined delay; and if moisture has not been detected during the predetermined delay, cause the inverter to restart generating the motor voltage to restart pumping.

In some embodiments, a method to drive a pump of a liquid pumping system comprises receiving a wetness signal from a wetness sensor; determining based on a wetness signal if moisture has been detected by the wetness sensor; discontinuing pumping by the pump responsive to determining that moisture has been detected; after discontinuing pumping, determining if moisture has been detected during a predetermined delay; and restarting pumping if moisture has not been detected during the predetermined delay.

In some embodiments, a motor drive to control a motor driving a pump of a liquid pumping system comprises an interface to receive a wetness signal from a wetness sensor, the wetness sensor adapted to detect moisture and communicate the wetness signal responsive to said moisture; a rectification circuit to generate a direct-current voltage; an inverter to invert the direct-current voltage into a motor voltage having a frequency proportional to a speed of the motor; an operating mode switch to select a lockout operating mode or a delay operating mode; and a controller structured to generate the motor voltage to maintain a pressure about a pressure setpoint and to discontinue controlling the pressure about the pressure setpoint responsive to the wetness signal, wherein in the lockout operating mode the controller restarts controlling the pressure about the pressure setpoint responsive to a lockout reset, and wherein in the delay operating mode the controller restarts controlling the pressure about the pressure setpoint responsive to a predetermined delay.

In some variations of the present embodiment, the switch comprises a physical switch or a logic switch.

In some variations of the present embodiment, in the delay operating mode the controller restarts controlling the pressure about the pressure setpoint responsive to the predetermined delay if the interface no longer receives the wetness signal.

In some variations of the present embodiment, the controller is further structured to discontinue controlling the pressure about the pressure setpoint responsive to a second wetness signal, and to restart controlling the pressure about the pressure setpoint responsive to a second predetermined delay, the second predetermined delay being longer than the predetermined delay. In one example, the controller is further structured to discontinue controlling the pressure about the pressure setpoint responsive to a third wetness signal, and thereafter to restart controlling the pressure about the pressure setpoint only responsive to the lockout reset.

In some variations of the present embodiment, the controller is further structured to perform a leak test upon restarting and to discontinue controlling the pressure about the pressure setpoint responsive to a failed leak test. In one example, the controller is further structured to restart controlling the pressure about the pressure setpoint responsive to a second predetermined delay, the second predetermined delay being longer than the predetermined delay. In another example, the controller is further structured to, after performing the leak test, restart controlling the pressure about the pressure setpoint only responsive to the lockout reset.

In some embodiments, a method to drive a pump of a liquid pumping system comprises setting a lockout operating mode or a delay operating mode; controlling a pressure about a pressure setpoint; detecting wetness; discontinuing controlling the pressure about the pressure setpoint responsive to detecting the wetness; in the lockout operating mode, restarting controlling the pressure about the pressure setpoint responsive to a lockout reset, and in the delay operating mode, restarting controlling the pressure about the pressure setpoint responsive to a predetermined delay.

In some variations of the present embodiment, setting the lockout operating mode or the delay operating mode comprises actuating a physical switch.

In some variations of the present embodiment, setting the lockout operating mode or the delay operating mode comprises engaging a user interface in a smart device to remotely change the logic state of a logic switch in the motor drive.

In some variations of the present embodiment, in the delay operating mode the method further comprises restarting controlling the pressure about the pressure setpoint responsive to the predetermined delay and absence of the wetness signal. In one example, the method further comprises restarting controlling the pressure about the pressure setpoint responsive to a second wetness signal and absence of the wetness signal after a second predetermined delay, the second predetermined delay being longer than the predetermined delay. The method may further comprises locking out the motor drive responsive to a third wetness signal.

In some variations of the present embodiment, the method further comprises performing a leak test upon restarting and discontinuing controlling the pressure about the pressure setpoint responsive to a failed leak test. In one example, the method further comprises locking out the motor drive responsive to the failed leak test.

### DESCRIPTION OF THE DRAWINGS

The features and advantages of the disclosure will become more readily appreciated as the same become better understood by reference to the following detailed description when taken in conjunction with the accompanying drawings, where:

FIG. 1 is a diagrammatic view of a liquid supply system including a motor drive enclosed in a housing;

FIG. 2 is a block diagram of an embodiment of the motor drive of FIG. 1;

FIG. 3 is a block diagram of an embodiment of control logic of the motor drive of FIG. 1;

FIG. 4 is a flowchart of an embodiment of a method to control the liquid supply system of FIG. 1; and

FIG. 5 is a flowchart of another embodiment of a method to control the liquid supply system of FIG. 1.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the invention, and such exemplifications are not to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed herein are not intended to be exhaustive or limit the claims to the precise form disclosed in the following detailed description. Rather, the embodiments are chosen and described so that others skilled in the art may utilize their teachings. It will be understood that no limitation of the scope of the claims is thereby intended. The present invention includes any alterations and further modifications in the illustrated devices and described methods and further applications of the disclosed principles which would normally occur to one skilled in the art to which the disclosure relates.

Except where a contrary intent is expressly stated, terms are used in their singular form for clarity and are intended to include their plural form.

As used herein, the terms “comprises,” “comprising,” “containing,” and “having” and the like denote an open transition meaning that the claim in which the open transition is used is not limited to the elements following the transitional term. The terms “consisting of” or “consists of” denote closed transitions.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

Occurrences of the phrase “in one embodiment,” or “in one aspect,” herein do not necessarily all refer to the same embodiment or aspect.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

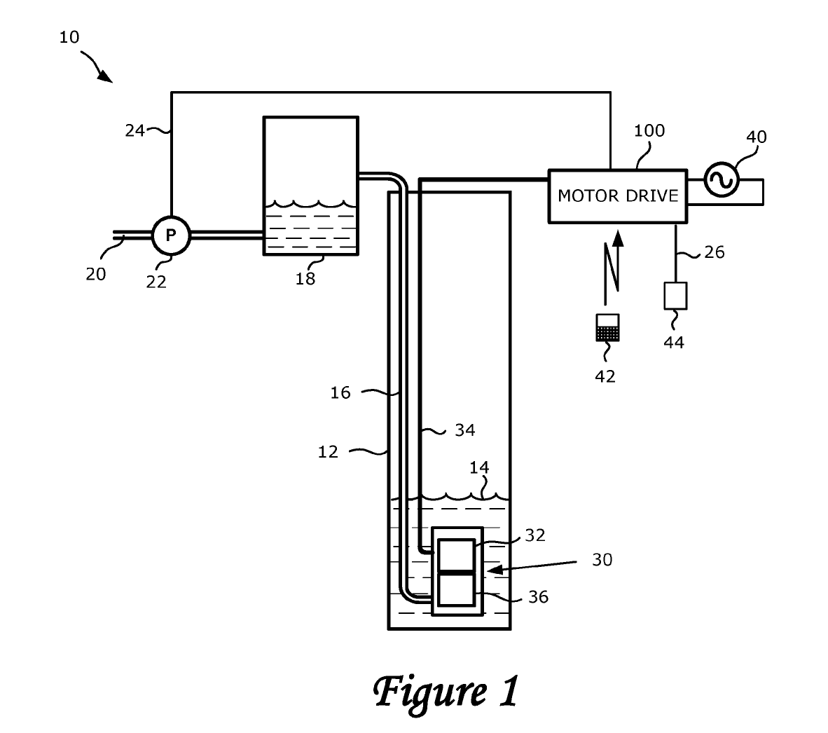

The foregoing exemplary embodiments of the disclosure will now be described with reference to the figures. Referring to FIG. 1, a diagrammatic representation of a liquid supply system 10 is disclosed. Example liquids include water, gasoline fuel, diesel fuel, petroleum, oil, sewage, and combinations of such liquids with gases and solids, such as water and coal-based methane gas. Although the embodiments below may be described with reference to water, the invention is not so limited and the principles and advantages thereof may be applicable to any liquid. Liquid supply system 10 comprises a reservoir 12 containing water 14 which is pumped by a pump unit 30 through a conduit 16, optionally via a reservoir 18, e.g. a pressure tank, to a conduit 20 of a closed system. Pump unit 30 includes a pump 36 driven by a motor 32 which is powered by a motor drive 100 via power conductors 34. The size of reservoir 12, which is interposed between pump unit 30 and a pressure sensor, affects the response of the system. In one example, motor drive 100 is a variable frequency drive (VFD) and pump 36 is a conventional centrifugal pump. Power conductors 34 may comprise two or more wires to provide single or three phase power to motor 32.

During operation of the system, water 14 flows out of conduit 20. For example, the system may be a water system in a home, in which case water flows out of conduit 20 when a faucet is opened or an irrigation system is turned on. Constant pressure ensures the heads of the irrigation system spray at a constant distance from the head to provide even and predictable irrigation. Fluid characteristics including pressure may be monitored with a pressure sensor 22 disposed in conduit 20 to generate a pressure signal useful to maintain pressure about a setpoint. The pressure signal is provided via line 24 connecting pressure sensor 22 and motor drive 100. An exemplary input device 60 is also shown. Input device 60 is provided to receive, from a user, input parameters such as setpoints and schedules. Input device 60 may comprise a smart device wirelessly coupled to a motor drive. Example smart devices include computers, smart phones and tablets. Reservoir 12 may be an aboveground or underground tank, a well casing, or any other reservoir containing water 14. It should be understood that while the present embodiment is described with reference to a pressure sensor, any process sensor may be used to control the pumping process. In one example, a flow sensor or a temperature sensor of the liquid is used to control the pumping process.

A wetness sensor 44 is electrically coupled to motor drive 100 by a cable 26 including a signal conductor and, optionally, a power conductor. Wetness sensor 44 detects moisture and causes motor drive 100 to discontinue pumping. In various embodiments, the signal conductor in cable 26 is energized while wetness sensor 44 does not detect moisture. When wetness sensor 44 detects moisture it de-energizes the signal conductor which communicates a wetness signal to motor drive 100. Responsive to the loss of energy on the signal conductor motor drive 100 discontinues pumping by pump unit 30. Motor drive 100 discontinues pumping by reducing the motor voltage to a value below which motor 32 does not drive the pump, typically at a voltage corresponding to less than 30 Hertz, preferably a voltage corresponding to less than 10 Hertz, and more preferably a voltage corresponding to 0 Hertz.

The wetness sensor may comprise an impedance circuit which, when bridged by a liquid, such as water, changes its impedance. Suitable electronic circuits measure the impedance and activate a contact responsive to a reduction in the impedance. The contact may be a normally open or normally closed contact. The wetness input is electrically coupled to the contact and detects the change in state. Other known or future developed circuits to detect moisture may be used. The wetness circuit may, optionally, include a delay circuit which causes the change in state of the contact only if wetness detection persists. The delay circuit may comprise a resistor-capacitor (RC) circuit whose time constant tau determines the delay. Accordingly, the wetness signal may be an instantaneous wetness signal or a persistent wetness signal.

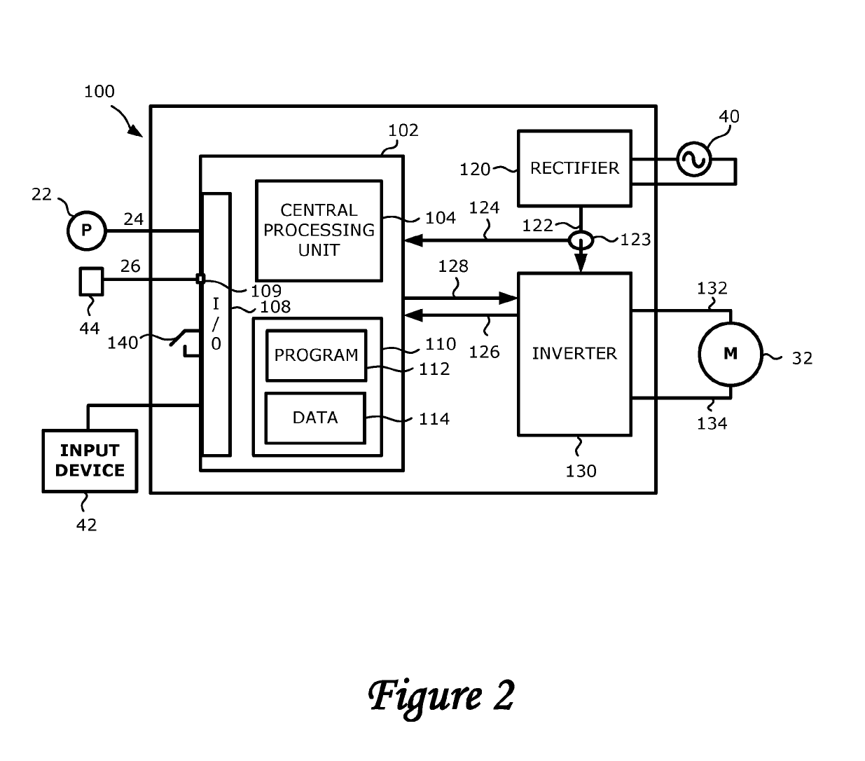

FIG. 2 illustrates an embodiment of motor drive 100 comprising a controller 102, a rectifier 120 and an inverter 130. As shown, controller 102 includes a CPU 104 configured to access a memory device 110 and execute processing instructions from a software application, exemplified by program 112, based on data 114. Techniques for generating motor voltages according to characteristics of a command signal are known in the art. In one example, a technique comprises storing values in a table corresponding to samples of an operating curve. The operating curve is typically a substantially straight line defining a volts-hertz relationship. When the control system determines a desired operating speed, which defines an operating frequency, the motor drive looks up a voltage corresponding to the frequency. The motor drive then generates a motor voltage based on the voltage and the frequency. In another example, a formula or a function embodying the operating curve characteristics is used by CPU 104 to generate the desired motor voltages.

Rectifier 120 is powered by a power source 40 and includes any rectification circuit well known in the art, e.g. a diode bridge, to convert alternating-current (AC) voltage supplied by power source 40 into direct-current (DC) voltage which it supplies to inverter 130. Inverter 130 receives DC power from rectifier 120 through a conductor 122 and converts the DC power into an AC motor power. It should be understood that rectifier 120 may be excluded. In variations of the present embodiment, a DC voltage source provides power to inverter 130. Examples of DC voltage sources include batteries and solar panels.

CPU 104 receives inputs through an I/O interface 108 and outputs a command signal over line 128 to inverter 130. In one example, the command signal is provided to a pulse-width-modulated (PWM) module having power switches and switching control logic which generates the appropriate gating signals for the power switches to convert the DC power to the AC motor voltage suitable to drive motor 32, provided to motor 32 via conductors 132, 134. Current drawn by inverter 130 from rectifier 120 is sensed by a current sensor 123 and a current signal is provided by current sensor 123 to CPU 104 by conductor 124. Motor voltage feedback can also be provided, for example through conductor 126 connecting inverter 130 and controller 102. Motor voltages may also be generated with other known or later developed drive topologies programmed in accordance with embodiments of the disclosure.

Optionally, motor drive 100 may comprise an operating mode switch configured to enable the user to switch between a lockout operating mode and a delay operating mode. A hardware switch or a logic switch may be used. A hardware switch 140 is shown. An example switch 140 comprises a depress-in-place (DIP) switch positioned on a circuit board of the motor drive. A logic switch may be implemented in control logic, for example as a soft switch programmable with a user interface.

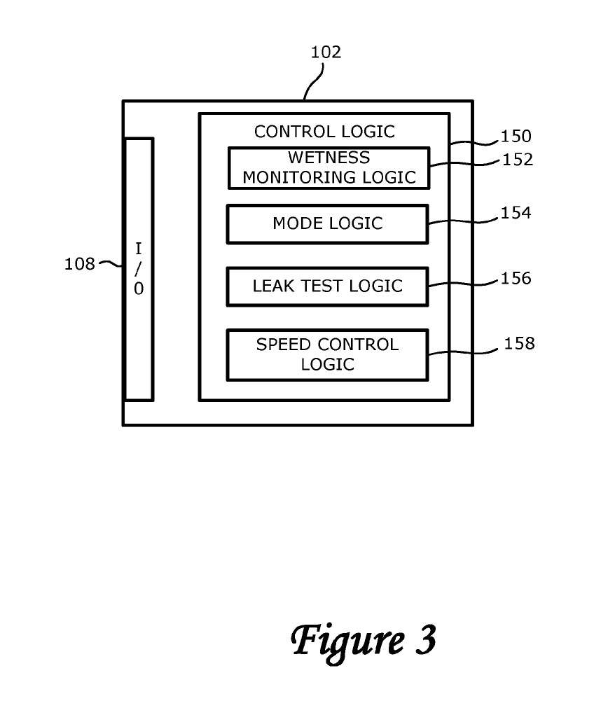

Referring to FIG. 3, in a more general embodiment the controller comprises control logic 150 operable to generate the command signal. Control logic 150 may comprise wetness monitoring logic 152, mode logic 154, leak test logic 156, speed control logic 158, and any other additional or optional logic configured to implement desired functionality. As described herein, wetness monitoring logic 152 may determine the presence or absence of moisture based on a wetness signal received from a wetness sensor. Mode logic 154 may determine whether the user selected a delay operating mode or a lockout operating mode, and implement control logic responsive to the selection. Leak test logic 156 may perform a test to determine whether a leak in the fluid system exists. Speed control logic 158 may output command signals to inverter 130 based on a difference between a process variable obtained from a process sensor and a process setpoint, to control the speed of the motor to maintain the process variable about the process setpoint.

The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

Advantageously, the features described herein protect or give the user an opportunity to protect the environment in case of a flood condition. The flood condition may arise for a multitude of reasons. If a pipe is broken, the system will not be able to maintain pressure and will continue to pump or will even increase pumping rates in an attempt to do so. Water flowing through the broken pipe will thus flood the environment. By environment it is meant, in the present context, the space surrounding the broken pipe and contiguous areas. A flood condition may also occur if a pressure tank breaks. Additionally, a flood condition may develop as a result of a broken or damaged transducer or opening of a pressure relief valve. If the transducer fails to operate the system may continue raising the pressure until the pressure relief valve opens to protect the pipes. When the relief valve opens, water floods the environment. Another flood condition cause is a too high pressure set point, which a user may set by mistake. A flood condition may further develop in case of a leak in a system. When a leak develops, the pump operates continuously to try to reach the setpoint pressure and while the flood condition develops more slowly than in the case of a broken pipe, a flood condition develops nonetheless. The leak may be indistinguishable from a small faucet that is open or other proper operation of the system, such as demand from a reverse osmosis system or a water source heat pump. Therefore the leak test described below may be performed multiple times or the delay period required for reset in the delay operating mode may be extended to distinguish small leaks from appropriate uses. A small leak can still cause flooding, but it requires more time to do so.

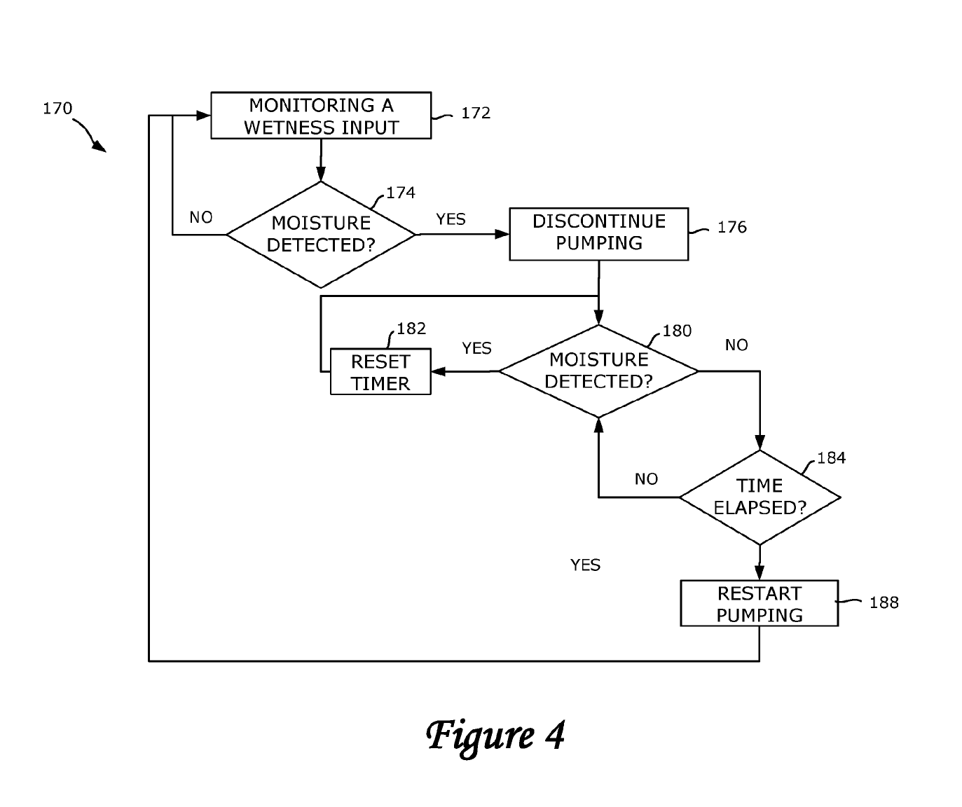

An embodiment of a control method will now be described with reference to a flowchart 170 illustrated in FIG. 4. The method begins at 172, by monitoring a wetness input. The wetness input may be comprised in I/O 108.

The method continues at 174, by determining if moisture has been detected. Wetness monitoring logic 152 may monitor wetness input 109 at regular intervals to detect a state change of the input. The state change may indicate the presence or absence of moisture, depending on the preceding state. Wetness monitoring logic 152 may indicate the presence of moisture if wetness is persistent to prevent nuisance trips. Wetness monitoring logic 152 may apply a time delay, for example 3 seconds, and determine the presence of moisture if the moisture signal indicates the presence of moisture during the time delay. In one example, moisture must be sensed periodically over the time delay to determine the presence of moisture. In another example, moisture must be sensed to trigger the time delay and at least at the end of the time delay to determine the presence of moisture.

If moisture was not detected, the method continues to monitor the wetness input at 172. If it has been detected, at 176 the method continues by discontinuing pumping. Discontinuing pumping may be performed by controller 120 issuing a command signal to the inverter to cease generating the motor voltage. Speed control logic 158 may issue the command signal based on an instruction from wetness monitoring logic 152 indicating the presence of moisture.

After discontinuing pumping, the method continues to monitor for moisture, at 180. If moisture is detected, a timer is reset at 182. If moisture is not detected, and the time has elapsed, at 184, then the motor is restarted, at 188, to restart pumping. If the time has not elapsed, monitoring for moisture continues. In sum, after a predetermined delay during which moisture is not detected, pumping continues by restarting the motor.

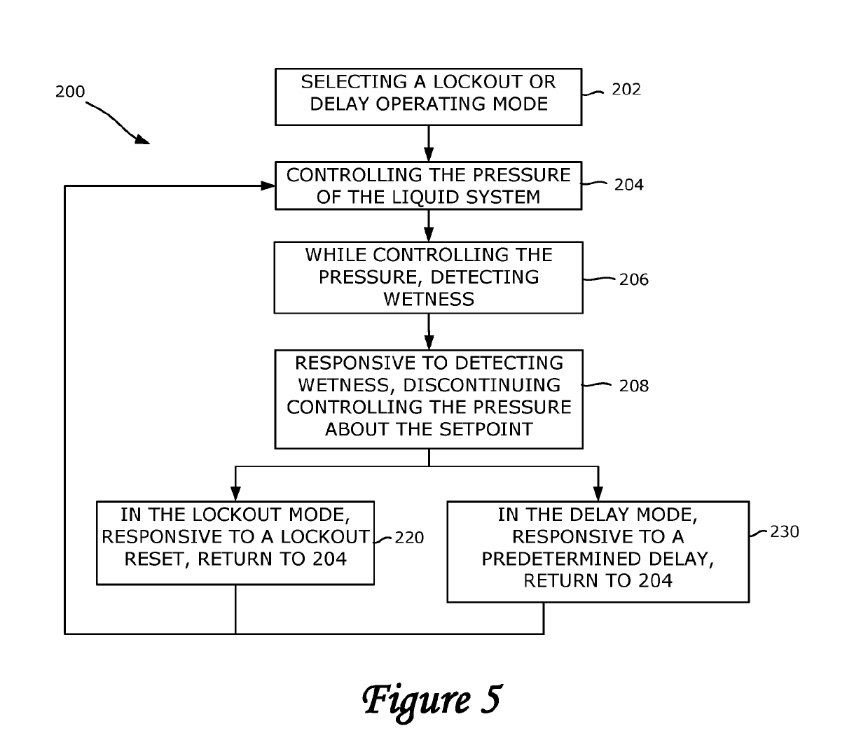

If the motor drive includes mode logic 156, then restarting of the motor occurs automatically in the delay operating mode. In the lockout operating mode, restarting of the motor is enabled, but the motor is only started after the lockout is reset, as described below with reference to FIG. 5.

Another embodiment of a control method will now be described with reference to a flowchart 200 illustrated in FIG. 5. The present embodiment may be performed by mode logic 154 in conjunction with wetness monitoring logic 152. The method begins by selecting, at 202, a lockout or delay operating mode. Selecting comprises changing the operating mode switch from lockout to delay, or vice versa, and also comprises choosing to leave the operating mode switch in its present state if that is the desired mode of operation.

The method continues by controlling, at 204, the pressure of the liquid system. Controlling comprises monitoring the pressure and generating motor control signals to alter the speed of the motor to maintain the pressure about the setpoint. Controlling also comprises stopping the motor if there is no water demand. Although the method is described with reference to a pressure of the liquid, any process variable may be used instead.

The method further comprises, while controlling the pressure, detecting, at 206, wetness. A wetness signal may be provided by wetness sensor 44 as described previously, in which case detecting wetness comprises monitoring an input and detecting the state change of the input.

The method further comprises, responsive to detecting wetness, at 208 discontinuing controlling the pressure about the setpoint. In the present context, discontinuing controlling the pressure comprises reducing the speed of the motor regardless of the setpoint.

The method further comprises, at 220, in the lockout operating mode and responsive to a lockout reset, monitoring the pressure and generating motor control signals to alter the speed of the motor to maintain the pressure about the setpoint. Alternatively, at 230, in the delay operating mode and responsive to a predetermined delay, monitoring the pressure and generating motor control signals to alter the speed of the motor to maintain the pressure about the setpoint.

The lockout operating mode, in which the motor speed is reduced to discontinue pumping and is maintained at that level until a user resets the lockout, is advantageous in the event that the user can be present to reset the lockout. However, the lockout operating mode is not as practical if the user is not present and there is water demand. The delay operating mode, on the other hand, enables the motor drive to operate after the predetermined delay which may be set to allow the flood condition to dry out. For example, the delay may be set to several hours. After the delay, the motor drive may automatically restart and thus maintain the pressure of the system even if the user is not present to reset the drive. A potential disadvantage of the delay operating mode is that even after the flood condition has dried out, the cause of the flood condition may have not been resolved. In variations of the present embodiment, the motor drive does not automatically restart after the delay if there are sensors indicating an unknown state or a fault. In other words, if the motor drive determines that it is unclear whether the cause of the flood condition has been resolved, the motor drive may not automatically restart. Alternatively, the motor drive may automatically start and after a short period of time perform a leak test to determine if there is a leak in the system or if the leak in the system remains, and shut down if it determines that a leak is still present. Of course the system may also restart and, if the cause of the wetness remains, shut down again upon detection of wetness. In a further variation, the motor drive will not restart if the wetness sensor continues to detect wetness, and will restart once the wetness sensor indicates the absence of wetness if the predetermined delay has timed out.

In various embodiments, in the delay operating mode of operation the motor drive may restart several times but under different conditions. In one example, the motor drive includes a first and a second predetermined delay. The motor drive restarts after the first predetermined delay the first time it detects wetness and then, the second time it detects wetness, it restarts after the second predetermined delay, which is longer than the first. After a certain amount of time after the restart, if the motor drive does not detect wetness, a counter tracking the number of resets after wetness has been detected is cleared so that if wetness is sensed again, for example a month later, the motor drive treats the wetness signal as if it were the first wetness signal and not the second or third. In another example, after the second restart the motor drive switches to the lockout operating mode of operation and only restarts after the user resets the lockout. Resetting the lockout may be performed by shutting the motor drive off and back on, or by actuating a switch provided for that purpose, which includes selecting a reset function on a user interface presented in a smart device.

In various embodiments, the motor drive is further structured to perform a leak test upon restarting and to discontinue controlling the pressure about the pressure setpoint responsive to a failed leak test. The leak test may be performed by leak test logic 156. The leak test may be performed by pumping to a predetermined pressure, stopping the pump, and determining if the pressure decreases by a predetermined amount in a given amount of time. For example, if the pressure drops 2 pounds per square inch (PSI) in one minute, the controller may determine that the pressure drop is due to a leak, which constitutes a failed leak test. The predetermined amount and given amount of time are based on the system. In some embodiments, the controller locks out after a failed leak test. Leak test logic 156 in conjunction with speed control logic 158 may control the speed of the motor to increase the pressure and to stop the motor prior to determining if the pressure decreases by a predetermined amount in the given time.

In some embodiments, the liquid supply system may include a user interface which provides the user an opportunity to remotely reset the lockout. The user may access with the user interface, generated by an application in a smart device or computer in any manner well known in the art, a cloud service communicatively coupled to the motor drive. The cloud service may provide the user information about the motor drive and other information. The user may remotely connect to the cloud service with the smart device to review the performance of the motor drive. The cloud service may, for example, receive information from the motor drive including fault codes, and the cloud service may include a database correlating the fault codes to fault descriptions and also a listing of individuals designated to receive alerts. The alerts would, based on the fault codes, communicate via text message or email a description of the fault, such as wetness, inability to maintain pressure, or other motor drive faults. The user may then take a responsive action. The user may also be able to change the pressure setpoint remotely using the user interface on the smart device.

The logic switch, which may be configured by the user with the user interface, enables the user to change the mode of operation of the drive between delay and lockout operating modes, from a remote location. For example, the user may be able to change the set point of the system and also switch from delay to lockout or lockout to delay operating modes with a smart device via the internet. In operation, the motor drive may be set, for example, to lockout operating mode most of the time but to delay operating mode if a user is traveling and not able to check the environment. The lockout operating mode may require the user to power the drive off and on to reset the lockout, for example, which the user cannot do while traveling. Of course, the operating mode switch enables the user to set the delay or lockout operating modes of operation at his/her discretion; the examples given above are provided merely to explain the functionality of the controller and in no way limit how the user may use the system.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor drive to control a motor driving a pump of a fluid pumping system, the motor drive comprising:
an interface adapted to receive a wetness signal from a wetness sensor operable to sense moisture;
an inverter to generate a motor voltage to pump a liquid; and
a controller including control logic operable to:
determine based on the wetness signal if moisture has been detected by the wetness sensor;
cause the inverter to discontinue generating the motor voltage to discontinue pumping responsive to determining that moisture has been detected;
after causing the inverter to discontinue generating the motor voltage, determine if moisture has been detected during a predetermined delay; and
if moisture has not been detected during the predetermined delay, cause the inverter to restart generating the motor voltage to restart pumping.

2. The motor drive of claim 1, further comprising an operating mode switch to select a lockout operating mode or a delay operating mode, wherein the control logic is further structured to automatically restart generating the motor voltage if moisture has not been detected during the predetermined delay, and wherein the control logic is further structured to restart generating the motor voltage in the lockout operating mode responsive to a lockout reset if moisture has not been detected during the predetermined delay.

3. (canceled)

4. The motor drive of claim 2, wherein the controller is further structured to discontinue pumping responsive to a second wetness signal, and to restart pumping if moisture has not been detected during a second predetermined delay which is longer than the predetermined delay.

5. (canceled)

6. The motor drive of claim 2, wherein the controller is further structured to perform a leak test upon restarting pumping and to discontinue pumping responsive to a failed leak test.

7. The motor drive of claim 1, wherein the controller is further structured to perform a leak test upon restarting pumping and to discontinue pumping responsive to a failed leak test.

8. The motor drive of claim 1, wherein the control logic determines that moisture has been detected by the wetness sensor if the moisture signal persists for a predetermined time.

9. The motor drive of claim 8, wherein the predetermined time is at least 1 second.

10. (canceled)

11. The motor drive of claim 10, wherein the predetermined time comprises 3 seconds.

12. A method to drive a pump of a liquid pumping system, the method comprising:
receiving a wetness signal from a wetness sensor;
determining based on a wetness signal if moisture has been detected by the wetness sensor;
discontinuing pumping by the pump responsive to determining that moisture has been detected;
after discontinuing pumping, determining if moisture has been detected during a predetermined delay; and
restarting pumping if moisture has not been detected during the predetermined delay.

13. The method of claim 12, further comprising:
setting a lockout operating mode or a delay operating mode;
controlling a pressure about a pressure setpoint;
after discontinuing pumping, in the lockout operating mode restarting pumping and controlling the pressure about the pressure setpoint if moisture has not been detected during the predetermined delay responsive to a lockout reset, and in the delay operating mode, automatically restarting pumping and controlling the pressure about the pressure setpoint responsive to moisture not having been detected during the predetermined delay.

14. The method of claim 13, wherein setting the lockout operating mode or the delay operating mode comprises actuating a physical switch.

15. The method of claim 13, wherein setting the lockout operating mode or the delay operating mode comprises engaging a user interface in a smart device to remotely change the logic state of a logic switch in the motor drive.

16. The method of claim 12, further comprising discontinuing pumping responsive to a second wetness signal and restarting pumping responsive to an absence of the wetness signal after a second predetermined delay, the second predetermined delay being longer than the predetermined delay.

17. The method of claim 12, further comprising discontinuing pumping responsive to a second wetness signal received after restarting pumping following the predetermined delay, and restarting pumping if moisture has not been detected during a second predetermined delay, the second predetermined delay being longer than the predetermined delay.

18. The method of claim 17, further comprising locking out the motor drive responsive to a third wetness signal received after restarting pumping following the second predetermined delay.

19. The method of claim 12, further comprising performing a leak test after restarting pumping and discontinuing pumping responsive to a failed leak test.

20. The method of claim 19, further comprising locking out the motor drive responsive to the failed leak test.

21. The method of claim 12, wherein determining if moisture has been detected by the wetness sensor comprises determining that the moisture signal persisted for a predetermined time.

22. The method of claim 21, Therein the predetermined time is greater than 1 second.

23. (canceled)

24. The method of claim 21, predetermined time comprises 3 seconds.
